(19) United States
(12) Patent Application Publication
(10) Pub. No.: US 2013/0078332 A1
(43) Pub. Date: Mar. 28, 2013

(54) NANOIMPRINTING MOLD AND METHOD FOR PRODUCING THE NANOIMPRINTING MOLD

(71) Applicants: Naotoshi SATOU, Haibara-gun (JP); Kazuyuki USUKI, Haibara-gun (JP); Satoshi WAKAMATSU, Haibara-gun (JP)

(72) Inventors: Naotoshi SATOU, Haibara-gun (JP); Kazuyuki USUKI, Haibara-gun (JP); Satoshi WAKAMATSU, Haibara-gun (JP)

(73) Assignee: FUJIFILM CORPORATION, Tokyo (JP)

(21) Appl. No.: 13/627,642

(22) Filed: Sep. 26, 2012

(30) Foreign Application Priority Data
Sep. 27, 2011 (JP) 2011-210253

(51) Int. Cl. B29C 59/02; B23K 20/22; B23K 31/00

(52) U.S. Cl. 425/470; 228/164

(57) ABSTRACT

A nanoimprinting mold having high durability enables reduction of thickness fluctuations in resist. The mold is equipped with a patterned base plate having a patterned region, in which a fine pattern of protrusions and recesses is formed, on a first surface thereof, and a second surface having a 3σ value related to a height difference distribution within a range from 1 nm to 6 nm; a hollowed base plate having a hollowed shape at least at a portion corresponding to the patterned region and a thickness greater than or equal to that of the patterned base plate; and a metal film formed between the patterned base plate and the hollowed base plate so as to bond the second surface of the patterned base plate and a surface of the hollowed base plate that faces the second surface.

### BACKGROUND OF THE INVENTION

1. Field of the Invention

The present invention is related to a nanoimprinting mold, and a method for producing the nanoimprinting mold.

2. Description of the Related Art

There are high expectations regarding utilization of pattern transfer techniques that employ a nanoimprinting method to transfer patterns onto resist coated on objects to be processed, in applications to produce magnetic recording media such as DTM (Discrete Track Media) and BPM (Bit Patterned Media) and semiconductor devices.

Nanoimprinting is a pattern forming technique which was developed based on embossing techniques which are well known in the production of optical disks. Specifically, in the nanoimprinting method, a mold (commonly referred to as a mold, a stamper, or a template), on which a pattern of protrusions and recesses is formed, is pressed against resist coated on a substrate, which is an object to be processed. Pressing of the original onto the resist causes the resist to mechanically deform or to flow, to precisely transfer the fine pattern. If a mold is produced once, nano level fine structures can be repeatedly molded in a simple manner. Therefore, the nanoimprinting method is an economical transfer technique that produces very little harmful waste and discharge. Therefore, there are high expectations with regard to application of the nanoimprinting method in various fields.

Conventionally, the aforementioned nanoimprinting operations are executed utilizing a mold having a flat discoid base plate, on a surface of which a pattern of protrusions and recesses is formed. However, in the case that such a mold is utilized, the entirety of the surface on which the pattern of protrusions and recesses is formed closely contacts resist, and there is a problem that mold release properties deteriorate.

In view of this problem, nanoimprinting utilizing molds that have recesses on a surface opposite a surface on which a pattern of protrusions and recesses is formed has been being developed, as disclosed in Japanese Unexamined Patent Publication No. 2009-170773 and in PCT Japanese Publication No. 2009-536591.

Specifically, a mold 8 of Japanese Unexamined Patent Publication No. 2009-170773 has a pattern 81 of protrusions and recesses formed on a surface thereof, and a recess 82 on a surface opposite that on which the pattern 81 is formed, as illustrated in FIG. 7A. This mold is produced by removing the surface of a base plate, opposite the surface on which the pattern 81 is formed, by an etching method or the like to form the recess 82.

Meanwhile, a mold 9 of PCT Japanese Publication No. 2009-536591 is of a structure in which a base plate 9a having a pattern 91 of protrusions and recesses is bonded to an annular base plate 9b having a hollow center 92 by an adhesive agent 95.

In the case that a mold has a recess as described above, a separating force that operates in a separating direction opposite an adhesive force between resist and the mold causes forces to be applied in the vicinity of the recess when the mold is separated from the resist, causing the mold itself to bend. For this reason, the separating force operates in the periphery of the interface between the resist and the mold in a concentrated manner. Accordingly, separation can be initiated with a lesser amount of force than had been conventionally required. As the separation progresses, the separating force sequentially operates efficiently from the periphery toward the center. Therefore, mold release properties are improved.

However, the recess in the mold of Japanese Unexamined Patent Publication No. 2009-170773 is formed by an etching method, a lithography method, a laser processing method, or the like. Therefore, there is a problem that the flatness of a surface 84 (the bottom surface of the recess) opposite the surface on which the pattern of protrusions and recesses is formed cannot be guaranteed. In the case that the flatness of the surface 84 is poor and protrusions and recesses are present thereon, the poor flatness influences the surface on which the pattern of protrusions and recesses is formed, resulting in fluctuations in the thickness of resist after imprinting.

In the mold disclosed in PCT Japanese Publication No, 2009-536591, the base plates are bonded to each other by an organic adhesive agent. Therefore, the adhesive agent is exposed to ultraviolet light during an exposure step using ultraviolet light, causing a problem that the adhesive agent will deteriorate. This will be a factor in deterioration of the durability of the mold.

### SUMMARY OF THE INVENTION

The present invention has been developed in view of the foregoing circumstances. It is an object of the present invention to provide a nanoimprinting mold having high durability and enables reduction of thickness fluctuations in resist. It is another object of the present invention to provide a method for producing such a nanoimprinting mold.

A mold of the present invention that achieves the above object is a nanoimprinting mold, characterized by comprising:

a patterned base plate having a patterned region, in which a fine pattern of protrusions and recesses is formed, on a first surface thereof, and a second surface having a 3σ value related to a height difference distribution within a range from 1 nm to 6 nm;

a hollowed base plate having a hollowed shape at least at a portion corresponding to the patterned region and a thickness greater than or equal to that of the patterned base plate; and

a metal film formed between the patterned base plate and the hollowed base plate so as to bond the second surface of the patterned base plate and a surface of the hollowed base plate that faces the second surface.

In the present specification, the expression “height difference distribution” refers to a distribution in height differences using an average value of the heights of a surface shape as a standard.

The term “3σ value” refers to the absolute value within a range of ±3σ from an average value when the height difference distribution approximates a Gaussian distribution. Here, σ is a standard deviation in the Gaussian distribution.

In the nanoimprinting mold of the present invention, it is preferable for the metal film to be formed in a shape that practically does not cover the second surface corresponding to the patterned region.

In the nanoimprinting mold of the present invention, it is preferable for the transmissivity of the metal film with respect to light having a wavelength of 400 nm or less to be 1% or less.

In the nanoimprinting mold of the present invention, it is preferable for the material of the metal film to be a metal material selected from a group of materials consisting of Ti, Al, Si, V, Cr, Fe, Co, Ni, Cu, Zn, Ga, Ge, Zr, Nb, Mo, Ru, Rh, Pd, Ag, In, Sn, Hf, Ta, Pt, and Au, or an alloy material that includes one or more materials selected from the group of materials.

A method for producing a nanoimprinting mold of the present invention is characterized by comprising:

preparing a patterned base plate having a patterned region, in which a fine pattern of protrusions and recesses is formed, on a first surface thereof, and a second surface having a 3σ value related to a height difference distribution within a range from 1 nm to 6 nm and a hollowed base plate having a hollowed shape at least at a portion corresponding to the patterned region and a thickness greater than or equal to that of the patterned base plate; and

bonding the second surface of the patterned base plate and a surface of the hollowed base plate via a metal film.

In the method for producing a nanoimprinting mold of the present invention, it is preferable for the bonding via the metal film to be executed by:

forming a first metal layer on the second surface of the patterned base plate;

forming a second metal layer on the surface of the hollowed base plate; and

placing the first metal layer and the second metal layer in close contact to bond the first and second metal layers.

In the method for producing a nanoimprinting mold of the present invention, it is preferable for the bonding of the first metal layer and the second metal layer to be executed by the atomic diffusion bonding method.

In the method for producing a nanoimprinting mold of the present invention, it is preferable for the material of the patterned base plate to be one of Si, Si oxide, Si nitride, quartz, and metal;

the thickness of the patterned substrate to be within a range from 0.3 mm to 1.5 mm; and

the bonding of the first metal layer and the second metal layer to be executed in a state in which external pressure is approximately is 5 g/cm².

In the method for producing a nanoimprinting mold of the present invention, it is preferable for the first metal layer to be formed in a shape that practically does not cover the second surface corresponding to the patterned region.

In the method for producing a nanoimprinting mold of the present invention, it is preferable for the material of the first metal layer and/or the second metal layer to be a metal material selected from a group of materials consisting of Ti, Al, Si, V, Cr, Fe, Co, Ni, Cu, Zn, Ga, Ge, Zr, Nb, Mo, Ru, Rh, Pd, Ag, In, Sn, Hf, Ta, Pt, and Au, or an alloy material that includes one or more materials selected from the group of materials.

The nanoimprinting mold of the present invention is characterized by comprising: a patterned base plate having a patterned region, in which a fine pattern of protrusions and recesses is formed, on a first surface thereof, and a second surface having a 3σ value related to a height difference distribution within a range from 1 nm to 6 nm; a hollowed base plate having a hollowed shape at least at a portion corresponding to the patterned region and a thickness greater than or equal to that of the patterned base plate; and a metal film formed between the patterned base plate and the hollowed base plate so as to bond the second surface of the patterned base plate and a surface of the hollowed base plate that faces the second surface. By having this structure, the mold of the present invention can guarantee the flatness of the surface opposite the surface on which the pattern of protrusions and recesses is formed. In addition, the problem of the bonded portion between the base plates deteriorating due to exposure to ultraviolet light will not occur. As a result, it becomes possible to reduce fluctuations in the thickness of resist, and also to improve the durability of the mold.

### BRIEF DESCRIPTION OF THE DRAWINGS

FIG. 1 is a perspective view that schematically illustrates a mold according to an embodiment of the present invention.

FIG. 2 is an exploded view that illustrates each constituent element of the mold of the embodiment.

FIG. 3 is a sectional view that schematically illustrates the mold of the embodiment.

FIG. 4A is a sectional view that illustrates a step of a method for producing the mold according to the embodiment of the present invention.

FIG. 4B is a sectional view that illustrates a step of the method for producing the mold according to the embodiment of the present invention.

FIG. 4C is a sectional view that illustrates a step of the method for producing the mold according to the embodiment of the present invention.

FIG. 5 is a sectional view that schematically illustrates a mold according to another embodiment of the present invention.

FIG. 6A and FIG. 6B are diagrams that illustrate evaluation standards for thickness fluctuations in resist films following imprinting.

FIG. 7A is a sectional diagram that schematically illustrates a conventional mold.

FIG. 7B is a sectional diagram that schematically illustrates another conventional mold.

### DESCRIPTION OF THE PREFERRED EMBODIMENTS

Hereinafter, embodiments of the present invention will be described with reference to the attached drawings. However, the present invention is not limited to the embodiments to be described below. Note that in the drawings, the dimensions of the constitutive elements are drawn differently from the actual dimensions thereof, in order to facilitate visual recognition thereof.

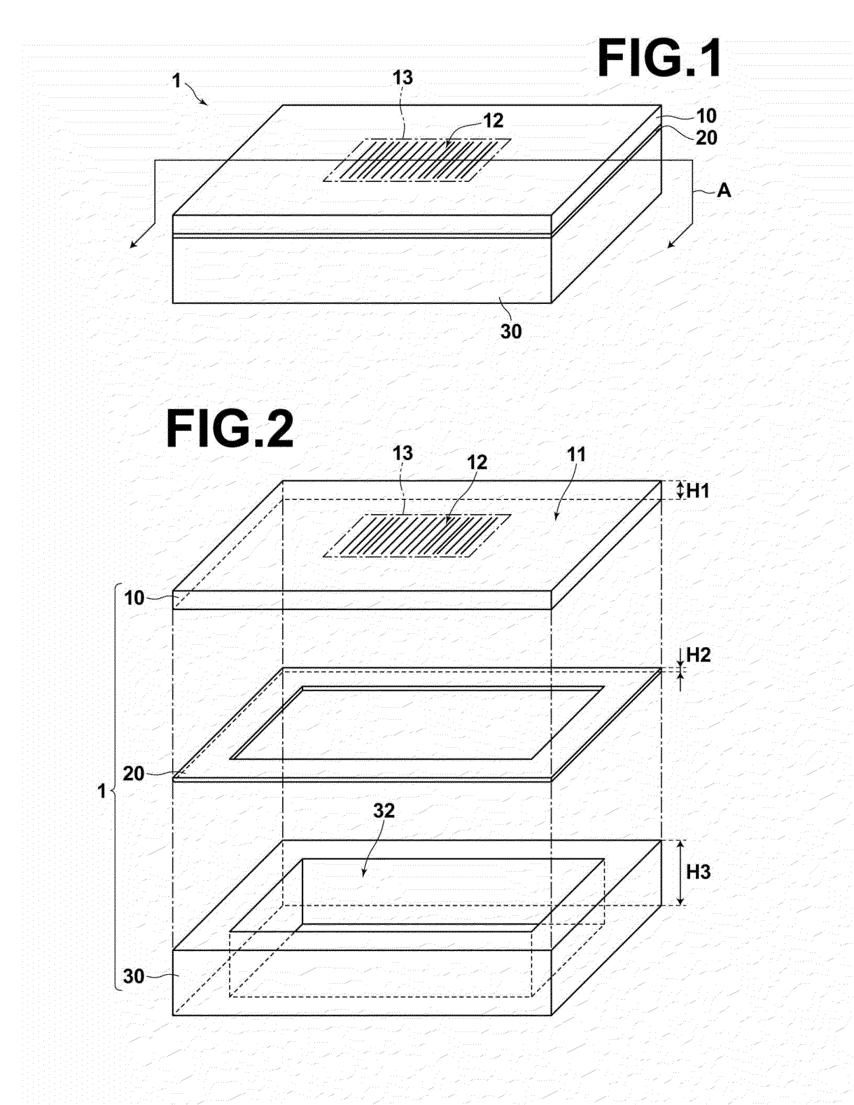

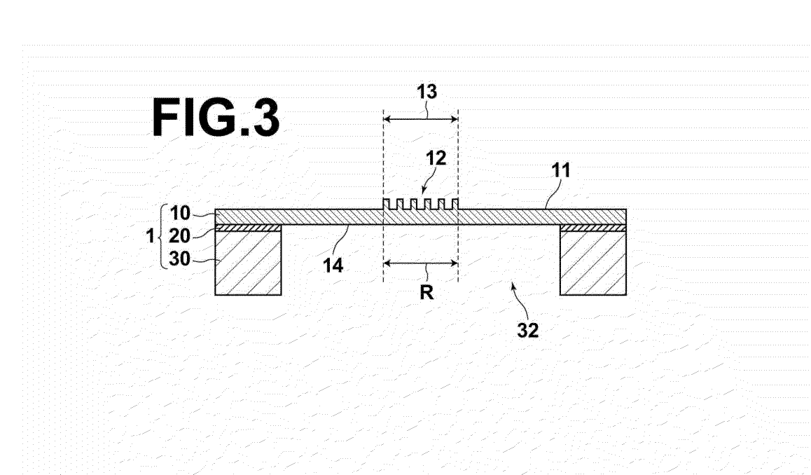

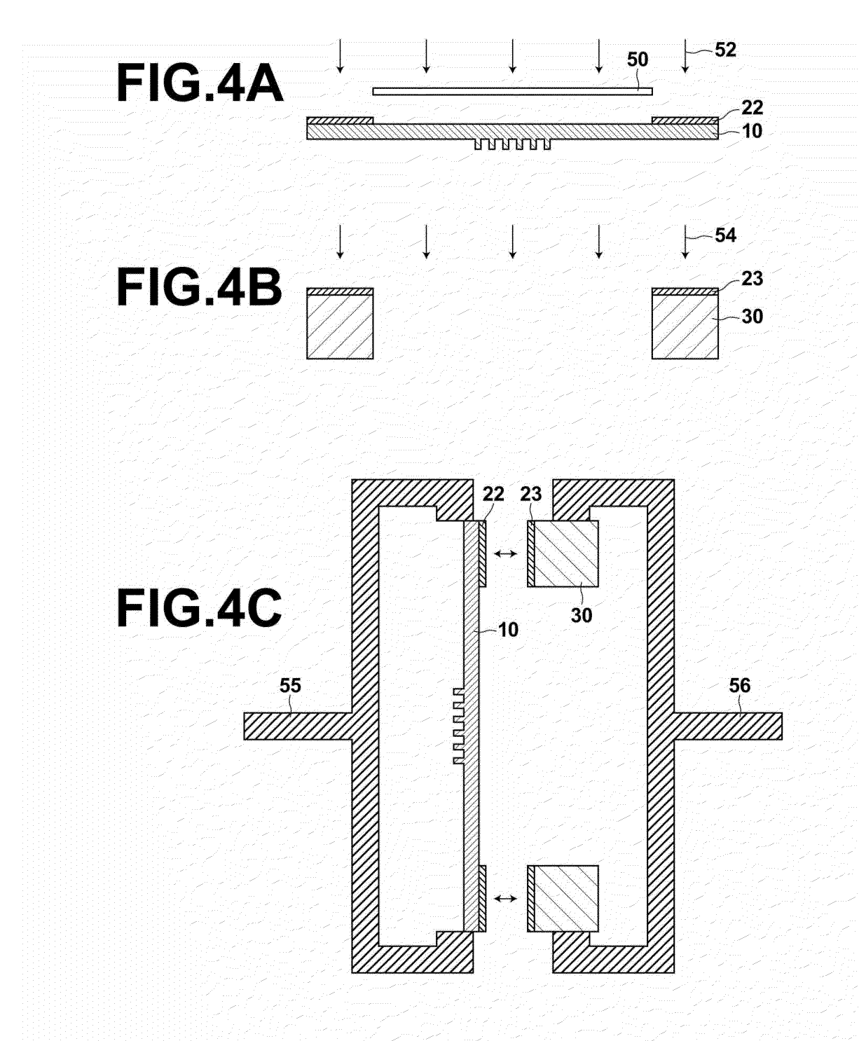

FIG. 1 is a perspective view that schematically illustrates a mold 1 according to an embodiment of the present invention. FIG. 2 is an exploded view that illustrates each constituent element of the mold 1 of the embodiment. FIG. 3 is a sectional view that schematically illustrates the mold 1 of the embodiment. FIG. 4A through FIG. 4C are sectional views that illustrate the steps of a method for producing the mold 1 according to the embodiment of the present invention.

As illustrated in FIG. 1 through FIG. 3, the mold 1 of the embodiment is equipped with a patterned base plate 10, a hollowed base plate 30, and a metal film 20 formed between the patterned base plate 10 and the hollowed base plate 30.

The method for producing the mold of the embodiment includes the steps of: forming the patterned base plate 10 having a patterned region 13 on a first surface 11 thereof; forming the hollowed base plate 30; depositing a material 52 on a second surface 14 of the patterned base plate 10 to form a first metal layer 22 (FIG. 4A); depositing a material 54 on a surface of the hollowed base plate 30 to be bonded with the second surface 14 to form a second metal layer 23 (FIG. 4B); and placing the first metal layer 22 and the second metal layer 23 in close contact with each other to bond them by the atomic diffusion bonding method (FIG. 4C).

Note that the order that the step of forming the patterned base plate 10, the step of forming the hollowed base plate 30, and the order that the step of forming the first metal layer 22 and the step of forming the second metal layer 23 are not limited to those described above.

### (Patterned Base Plate)

The patterned base plate 10 is a plate member having the patterned region 13, at which a pattern 12 of fine protrusions and recesses is formed, on the first surface 11 thereof and the second surface 14 having a 3σ value related to a height difference distribution within a range from 1 nm to 6 nm. The surface on which the pattern 12 of protrusions and recesses is formed is pressed against resist during nanoimprinting.

The shape of the pattern 12 of protrusions and recesses is designed as appropriate according to the shapes to be transferred onto resist. For example, the width of the protrusions, the heights of the protrusions, and the distances among protrusions in the pattern 12 of protrusions and recesses are within a range from 5 nm to 500 nm, within a range from 5 nm to 800 nm, and within a range from 5 nm to 800 nm, respectively. The shapes of the protrusions of the pattern 12 of protrusions and recesses are rectangles or dots in plan view, for example. In addition, there may be cases in which the shapes of the protrusions of the pattern 12 of protrusions and recesses have protrusions which are rectangular in plan view as basic units, and a plurality of protrusions are bonded at their peaks or share a portion of the sides thereof. In the present embodiment, the pattern 12 of protrusions and recesses is formed in the vicinity of the center of the patterned base plate 10. However, the present invention is not limited to this configuration. Note that the region of the surface 11 of the patterned substrate, at which the pattern 12 of protrusions and recesses is actually formed, is referred to as the “patterned region”.

The material of the patterned base plate 10 is not particularly limited, and may be selected as appropriate according to intended use. Examples of favorable materials include: Si, Si oxide, Si nitride, quartz, metal, and resin. Examples of metal materials include: metals, such as Ni, Cu, Al, Mo, Co, Cr, Ta, Pd, Pt, Au, etc.; and alloys thereof. From among the metal materials, Ni and Ni alloys are particularly preferable. Examples of resin materials include: PET (polyethylene terephthalate); PEN (polyethylene naphthalate); PC (polycarbonate); PMMA (polymethyl methacrylate); TAC (triacetate cellulose); low melting point fluorine resin; etc.

The thickness H1 of the patterned base plate 10 is not particularly limited. However, it is preferable for the patterned base plate 10 to have a degree of rigidity that causes bending to occur when the mold is separated from resist. For example, in the case that the material of the patterned base plate 10 is Si, Si oxide, Si nitride, quartz, or metal, it is preferable for the thickness H1 of the patterned base plate 10 to be within a range from 0.3 mm to 1.5 mm, more preferably a range from 0.5 mm to 1.2 mm, and most preferably a range from 0.6 mm to 1.0 mm.

The method by which the pattern 12 of protrusions and recesses is produced is not particularly limited. The pattern 12 of protrusions and recesses may be produced by the photo etching method described below, for example.

First, a photoresist film is provided on the surface of a Si substrate (or a quartz substrate), and a portion of the photoresist film corresponding to the pattern of protrusions and recesses is exposed and drawn with an electron beam. The exposed portions of the photoresist film are removed by a developing process, and the remaining photoresist is used as a mask to etch the surface of the substrate by RIE (Reactive Ion Etching), for example. The patterned base plate 10 having Si (or quartz) as a material is formed as a result. Alternatively, the mold produced in the manner above may be employed to execute a nanoimprinting process onto a Si substrate (or a quartz substrate) to transfer the pattern of protrusions and recesses thereon. Then, the surface of the substrate may be etched by RIE, for example.

The second surface 14 of the patterned base plate 10 is designed to have a 3σ value related to a height difference distribution within a range from 1 nm to 6 nm. By utilizing the base plate in which the flatness of the second surface 14 is guaranteed in this manner, fluctuations in the thickness of resist can be reduced. A more preferable range for the 3σ value is 1 nm to 3 nm. The 3σ value of the shape of the surface is measured with NewView 6300 by ZYGO.

It is preferable for the 3σ value to be calculated after the surface shape is measured for at least a 30 mm square range. Here, the measurement range is more preferably 40 mm square, and most preferably 50 mm square. These measurement ranges are preferred because height differences between two points which are comparatively remote from each other at a distance of approximately 1 mm can be reduced, by analyzing a more macroscopic range as the subject of evaluation of the height difference distribution of the surface shape. In addition, evaluations of fluctuations in the thickness of the photocurable resin film and of incomplete filling defects within a range corresponding to the entire region of a single semiconductor chip will be more reliable, taking the fact that a common size of a single semiconductor chip is 26 mm·33 mm.

The second surface 14 having the 3σ value within the range from 1 nm to 6 nm is realized by CMP (Chemical Mechanical Polishing), for example.

### (Hollowed Base Plate)

The hollowed base plate 30 is of a shape in which at least a portion R corresponding to the patterned region 13 is hollowed, and has a thickness H3 which is greater than or equal to the thickness H1 of the patterned base plate. The hollowed base plate 30 functions to reinforce the patterned base plate 10 and to improve the handling properties of the mold 1.

The expression “corresponding to the patterned region” refers to the spatial region R that overlaps the patterned region when the patterned region is viewed from above.

The size of the hollowed portion of the hollowed substrate 30 is set as appropriate to a size that will not inhibit bending of the patterned base plate 10, while taking the handling properties of the mold 1 into consideration.

The material of the hollowed base plate 30 is not particularly limited, and may be selected as appropriate according to intended use. Examples of favorable materials include: Si, Si oxide, Si nitride, quartz, metal, and resin. Examples of metal materials include: metals, such as Ni, Cu, Al, Mo, Co, Cr, Ta, Pd, Pt, Au, etc.; and alloys thereof. From among the metal materials, Ni and Ni alloys are particularly preferable. Examples of resin materials include: PET (polyethylene terephthalate); PEN (polyethylene naphthalate); PC (polycarbonate); PMMA. (polymethyl methacrylate); TAC (triacetate cellulose); low melting point fluorine resin; etc.

The thickness H3 of the hollowed base plate 30 is set to be greater than or equal to the thickness H1 of the patterned base plate 10, taking the handling properties of the mold 1 into consideration. For example, in the case that the material of the hollowed base plate 30 is Si, Si oxide, Si nitride, quartz, or metal, it is preferable for the thickness H3 of the hollowed base plate 30 to be within a range from 3 mm to 8 mm, more preferably a range from 4 mm to 7 mm, and most preferably a range from 5 mm to 6 mm.

The hollowed base plate 30 is produced by administering a grinding process or a laser process on the base plate to form the hollow portion.

Note that the hollowed base plate 30 may be of a structure in which a plurality of hollowed base plates are laminated.

### (Metal Film)

The metal film 20 is formed between the patterned base plate 10 and the hollowed base plate 30 to bond the second surface 14 of the patterned base plate 10 and the surface of the hollowed base plate 30 that faces the second surface 14. That is, the metal film 20 functions as a bonding agent that bonds the patterned base plate 10 and the hollowed base plate 30.

It is preferable for the material of the metal film to be a metal material selected from a group of materials consisting of Ti, Al, Si, V, Cr, Fe, Co, Ni, Cu, Zn, Ga, Ge, Zr, Nb, Mo, Ru, Rh, Pd, Ag, In, Sn, Hf, Ta, Pt, and Au, or an alloy material that includes one or more materials selected from the group of materials.

In the present embodiment, the metal film 20 is formed by forming the first metal layer on the second surface 14 of the patterned base plate 10, forming the second metal layer on the surface of the hollowed base plate 30 that faces the second surface 14, then by placing the first metal layer and the second metal layer in close contact. If the material of the first metal layer and the material of the second metal layer are different, the metal film 20 will be of a laminated structure.

An alternate method for forming the metal film 20 may be adopted, in which a metal layer is formed on the second surface 14 of the patterned base plate (or on the surface of the hollowed base plate 30 that faces the second surface 14), then placing the metal layer and the surface of the hollowed base plate 30 that faces the second surface 14 (or the second surface 14) into close contact.

The material of the metal layers is preferably a metal material selected from a group of materials consisting of Ti, Al, Si, V, Cr, Fe, Co, Ni, Cu, Zn, Ga, Ge, Zr, Nb, Mo, Ru, Rh, Pd, Ag, In, Sn, Hf, Ta, Pt, and Au, or an alloy material that includes one or more materials selected from the group of materials. In the case that the first metal layer and the second metal layer, different materials may be employed for the first metal layer and the second metal layer.

It is preferable for the metal film 20 to be of a shape that practically does not cover the portion of the second surface 14 corresponding to the patterned region 13. Such a shape is realized in FIG. 4A by use of a mask 50. The expression “practically does not cover” means that the transmissivity of light having a wavelength of 400 nm or less is 99% or greater at the portion of the second surface 14 corresponding to the patterned region 13. In this case, it is preferable for the transmissivity of the metal film (in the case that the metal film is present on the portion of the second surface 14 corresponding to the patterned region 13, the transmissivity of the metal film at portions other than that corresponding to the patterned region 13) with respect to light having a wavelength of 400 nm or less to be 1% or less.

By adopting this configuration, it becomes possible for light to be irradiated only onto the patterned region 13 when performing exposure from the side of the hollowed base plate 30. This is advantageous in that exposure can be performed only within a desired range when executing nanoimprinting operations using the step and repeat method.

### (Bonding Method)

The method by which the second surface 14 of the patterned base plate 10 and the surface of the hollowed base plate 30 are bonded via the metal film 20 is not particularly limited. However, it is preferable for the patterned base plate 10 and the hollowed base plate 30 to be bonded by the atomic diffusion bonding method. That is, the base plates are bonded utilizing diffusion of atoms between bonding surfaces under conditions of an external pressure to a degree that will not cause plastic deformation and a temperature less than or equal to the melting point of the materials.

In the bonding method that utilizes the atomic diffusion bonding method, the first metal layer 22 is formed on the second surface 14 of the patterned base plate 10 by the vapor deposition method in a vacuum (FIG. 4A), the second metal layer 23 is formed on the surface of the hollowed substrate 30 by the vapor deposition method in a vacuum (FIG. 4B), and the first metal layer and the second metal layer are placed into close contact while maintaining the state of vacuum, to bond them together (FIG. 4C), for example. Because the metal layers are in an active state immediately after they are formed, it is possible to efficiently induce diffusion of atoms utilizing this active state. Note that other deposition methods, such as the sputtering method, may be employed as an alternative to the aforementioned vapor deposition method.

Note that in the present invention, the rigidity of the patterned base plate 10 is low. Therefore, it is preferable for the bonding by the atomic diffusion method (the bonding of the base plates with the metal layers, and the bonding of the metal layers with each other) to be executed with an external pressure of approximately 5 g/cm². In this case, forces which are generated between the bonding surfaces (Coulomb's force, for example) as a result of the bonding surfaces approaching each other draw the bonding surfaces together, and diffusion bonding processes with the passage of time.

In addition, it is preferable for the bonding of the patterned base plate 10 and the hollowed base plate 30 to be performed in a state in which a handling member 55 holds the patterned base plate 10 and a handling member 56 holds the hollowed base plate 30 such that the base plates 10 and 30 are upright (that is, the surfaces of the base plates are parallel to the direction of gravity). This configuration is preferable, as it prevents bonding of the patterned base plate 10 and the hollowed base plate 30 while the patterned base plate 10 is flexed.

The mold 1 of the present invention is of a structure having a recess 32 by being configured as described above.

### Operational Effects of the Present Invention

The mold of the present invention is characterized by comprising: the patterned base plate 10 having the patterned region 13, in which the fine pattern 12 of protrusions, and recesses is formed, on the first surface 11 thereof, and the second surface 14 having a 3σ value related to a height difference distribution within a range from 1 nm to 6 nm; the hollowed base plate 30 having a hollowed shape at least at a portion corresponding to the patterned region 13 and a thickness greater than or equal to that of the patterned base plate; and the metal film 20 formed between the patterned base plate 10 and the hollowed base plate 30 so as to bond the second surface 14 of the patterned base plate 10 and a surface of the hollowed base plate 30 that faces the second surface 14. By having this structure, the mold of the present invention can guarantee the flatness of the surface opposite the surface on which the pattern of protrusions and recesses is formed. In addition, the problem of the bonded portion between the base plates deteriorating due to exposure to ultraviolet light will not occur. As a result, it becomes possible to reduce fluctuations in the thickness of resist, and also to improve the durability of the mold.

Further, in the case that the metal film 20 is formed to be of a shape that practically does not cover the second surface corresponding to the patterned region 13, it is possible to control a light irradiation range such that light is irradiated only onto the patterned region 13 when performing exposure from the side of the hollowed base plate 30.

### Design Modifications to the Embodiment

In the embodiment described above, the mold was rectangular in plan view. However, the mold of the present invention is not limited to this configuration, and the mold of the present invention may be discoid in plan view, for example. In this case, the shape of the hollowed base plate will be discoid, for example.

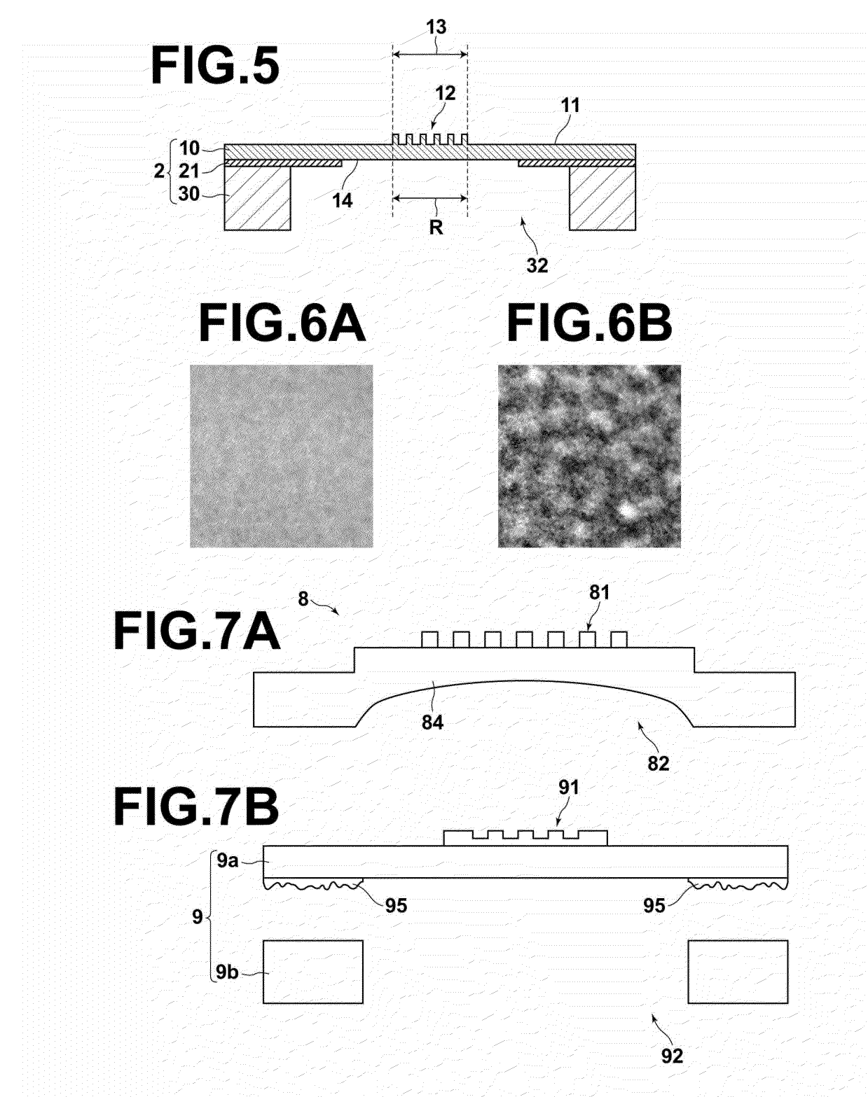

In addition, the above embodiment was described as a case in which the area of the metal film 20 matches the area of the bonding surface between the patterned base plate 10 and the hollowed base plate 30. However, the present invention is not limited to this configuration. For example, the mold of the present invention may be a mold 2 equipped with a metal film 21 having an area greater than the area of the bonding surface between the patterned base plate 10 and the hollowed base plate 30, as illustrated in FIG. 5.

### EXAMPLES

Examples of the mold of the present invention will be described below.

### Example 1

First, an 8 inch silicon wafer was prepared as a substrate for an imprinting stamper. Next, a positive electron beam resist (ZEP520 by Nippon Zeon K. K.) was coated on the silicon wafer, to form a resist film having a thickness of 50 nm on the silicon wafer by the spin coat method. Then, an electron beam lithography apparatus was employed to draw on portions of the resist film at a dose of 20 μC/cm², and a resist pattern was formed by a developing process.

Next, the silicon wafer was etched by an anisotropic dry etching method employing an ICP RIE apparatus using the resist film as a mask, to form a pattern of protrusions and recesses on the surface of the silicon wafer. The conditions for anisotropic etching were as follows: the flow volume of Cl₂ was 30 sccm; the flow volume of O₂ was 5 sccm; the flow volume of Ar was 80 sccm; the pressure was 2 Pa; the ICP power was 400 W; and the RIE power was 130 W. Then, the resist film was removed by an O₂ plasma ashing process, to obtain a silicon stamper. The ashing conditions were as follows: the flow volume of O₂ was 500 sccm, the pressure was 30 Pa; and the RF power was 1000 W.

Thereafter, a mold release process was administered onto the surface of the stamper, to form a mold release layer on the surface of the stamper. Durasurf™ HD-1101Z diluted to a concentration of 25% by OPTOOL™ HD-ZV by Daikin Industries, K. K. was utilized as the mold release material. The mold release process was administered by immersing the stamper in the mold release material at an immersion speed of 15 mm/sec and a draw up speed of 5 mm/sec, and then by rinsing the stamper in Vertrel™ XF-UP by Mitsui Dupont Fluorochemical K. K. at an immersion speed of 15 mm/sec and a draw up speed of 5 mm/sec.

Next, a quartz wafer having a thickness of 0.7 mm and a size of 6 inches was prepared as the substrate to become the base for the patterned base plate. With respect to the surface shape of the quartz wafer, a quartz wafer having a 3σ value related to a height difference distribution within a range from 1 nm to 3 nm was selected and utilized.

An imprinting resist fluid was coated on the quartz wafer to form a resist film. The aforementioned stamper was pressed against the resist film, then the resist film was cured by irradiating UV light thereon. Thereafter, the stamper was separated from the resist film, to form a resist film, onto which the pattern of protrusions and recesses has been transferred, on the quartz wafer.

Next, quartz wafer was etched by an anisotropic dry etching method employing an ICP RIE apparatus using the resist film as a mask, to form the pattern of protrusions and recesses of the stamper on the quartz wafer. The conditions for anisotropic etching were as follows: the flow volume of CHF₃ was 20 sccm; the flow volume of CF₄ was 20 sccm; the flow volume of Ar was 80 sccm; the pressure was 2 Pa; the ICP power was 300 W; and the RIE power was 50 W.

Then, the quartz wafer was processed to a 6 inch square size, to produce a patterned base plate formed by quartz.

Next, a quartz substrate on which a hollowing process has been administered in advance was prepared. A substrate 6 inches square in size and having a thickness of 5.365 mm was utilized.

Then, the surfaces of the two types of quartz substrates to be bonded to each other were cleansed by a UV ozone processing method. Thereafter, 5 nm thick Ti layers were formed on the surface of the patterned base plate opposite the surface on which the pattern of protrusions and recesses was formed and a surface of the hollowed base plate by the sputtering method in a vacuum chamber having a degree of vacuum of 1·10⁻⁶ Pa. The Ti layers were caused to contact each other within a vacuum, to produce a mold of the present invention. Note that no external pressure was applied when the Ti layers were caused to contact each other.

### Example 2

A mold was produced in the same manner as in Example 1, except that the thickness of the TI layers was 20 nm.

### Comparative Example 1

A stamper was produced in the same manner as in Example 1.

Then, a 6 inch square quartz substrate having a thickness of 6.35 mm was prepared. The pattern of protrusions and recesses of the stamper was transferred onto the quartz substrate by the same method as that employed for Example 1.

Further, a mold was produced by processing the surface of the quartz substrate opposite that on which the pattern of protrusions and recesses was formed to form a recess by a grinding process.

### Comparative Example 2

A mold was produced in the same manner as in Example 1 except that the patterned base plate and the hollowed base plate are bonded to each other employing an epoxy type adhesive agent.

### Comparative Example 3

A patterned base plate and a hollowed base plate were prepared in the same manner as Example 1.

Then, the surface of the patterned base plate opposite the surface on which the pattern of protrusions and recesses was formed and a surface of the hollowed base plate were pressed against each other and heat and pressure were applied to bond the surfaces to each other, thereby forming a mold.

### <Evaluation Method>

Fluctuations in the thickness of resist films during imprinting operations, leakage of ultraviolet light outside patterned regions, and durability for imprinting operations were evaluated for the molds of the Examples and the Comparative Examples as described below.

### <Evaluation of Fluctuations in Thickness of Resist Films During Imprinting Operations>

Evaluation of fluctuations in the thickness of resist films after imprinting operations was performed visually by ten people. Specifically, if the surface shape was as that illustrated in FIG. 6A, it was judged that fluctuations are not present in the thickness of resist film, and an evaluation of “Good” was rendered. In contrast, if the surface shape was as that illustrated in FIG. 6B, it was judged that fluctuations are present in the thickness of resist film, and an evaluation of “Poor” was rendered.

### <Evaluation of Leakage of UV Light Outside Patterned Regions>

Leakage of UV light outside patterned regions was evaluated by performing imprinting onto resist coated over a range greater than the patterned regions using each of the molds, then basing evaluations on the cured states of the resist outside the patterned regions. Specifically, cases in which the resist was not cured at all were judged as having achieved sufficient shielding of light, and evaluated as “Excellent”. Cases in which the resist was partly cured but it was possible to perform pattern transfer when the mold was pressed against the resist again were judged as having exhibited a light shielding effect, and evaluated as “Good”. Cases in which the resist was completely cured and pattern transfer was not possible when the mold was pressed against the resist were judged as not having any light shielding effect, and evaluated as “Poor”.

### <Evaluation of Durability for Imprinting Operations>

Evaluations regarding the durability for imprinting operations were performed by employing a high pressure UV lamp to irradiate the molds with ultraviolet rays having an energy of 100 J/cm² (1 mW/cm²·1 sec·100,000 shots), then judging whether the patterned base plates and the hollowed base plates could be separated at their bonding surfaces. Cases in which the patterned base plates and the hollowed base plates could not be separated were evaluated as “Good”, and cases in which the patterned base plates and the hollowed base plates could be separated were evaluated as “Poor”.

### <Total Evaluation>

Molds for which none of the three evaluation criteria above were evaluated as “Poor” were evaluated as “Good”, and molds for which at least one of the evaluation criteria were evaluated as “Poor” were evaluated as “Poor”.

### <Results>

Table 1 summarizes the results of the aforementioned evaluations.

TABLE 1

| | Fluctuations | Leakage of | Durability for | |
|---|---|---|---|---|
| | in Resist | Ultraviolet | Imprinting | Total |
| | Film Thickness | Light | Operations | Evaluation |
| Example 1 | Good | Good | Good | Good |
| Example 2 | Good | Excellent | Good | Good |
| Comparative | Poor | Poor | Good | Poor |
| Example 1 | | | | |
| Comparative | Good | Good | Poor | Poor |
| Example 2 | | | | |
| Comparative | Poor | Poor | Good | Poor |
| Example 3 | | | | |

The evaluation results for the mold produced as Example 1 are as follows. Fluctuations in the thickness of resist film were not observed, and resulted in an evaluation of “Good”. With respect to leakage of ultraviolet light, the Ti layers shielded ultraviolet light to a certain degree, and therefore the resist outside the patterned region cured somewhat, but pattern transfer thereto was still possible. With respect to durability, separation of the base plates at the bonding surfaces did not occur, resulting in an evaluation of “Good”.

The evaluation results for the mold produced as Example 2 are as follows. Fluctuations in the thickness of resist film were not observed, and resulted in an evaluation of “Good”. With respect to leakage of ultraviolet light, the Ti layers completely shielded ultraviolet light, and the resist outside the patterned region were not cured at all. With respect to durability, separation of the base plates at the bonding surfaces did not occur, resulting in an evaluation of “Good”.

The evaluation results for the mold produced as Comparative Example 1 are as follows. The height difference distribution of the bottom surface of the recess was great, and the protrusions and recesses thereof were reflected in the resist film after imprinting, resulting in generation of fluctuations in the thickness of the resist film. With respect to leakage of ultraviolet light, there was nothing to shield ultraviolet light, and therefore the resist outside the patterned region was completely cured. With respect to durability, there are no bonding surfaces between base plates, and therefore it was judged that deterioration did not occur.

The evaluation results for the mold produced as Comparative Example 2 are as follows. Fluctuations in the thickness of resist film were not observed, and resulted in an evaluation of “Good”. With respect to leakage of ultraviolet light, the adhesive agent shielded ultraviolet light to a certain degree, and therefore the resist outside the patterned region cured somewhat, but pattern transfer thereto was still possible. With respect to durability, the adhesive agent on the bonding surfaces deteriorated by irradiation of ultraviolet light, resulting in separation of the base plates at the bonding surfaces.

The evaluation results for the mold produced as Comparative Example 3 are as follows. Because heat and external pressure were applied to bond the base plates to each other, distortion was generated in the imprinting surface, resulting in fluctuations in the thickness of resist film being observed. With respect to leakage of ultraviolet light, there was nothing to shield ultraviolet light, and therefore the resist outside the patterned region was completely cured. With respect to durability, no deterioration due to ultraviolet light occurred because an adhesive agent was not utilized at the bonding surfaces between the base plates. Therefore, separation of the base plates at the bonding surfaces did not occur, resulting in an evaluation of “Good”.

These results proved that fluctuations in the thickness of resist films after imprinting can be eliminated even in nanoimprinting that employs fine patterns of protrusions and recesses and that durability of molds with respect to ultraviolet light can be improved by utilizing the mold of the present invention.

Further, it was understood that leakage of ultraviolet light into adjacent regions can be prevented when performing continuous imprinting operations in the case that the metal film is formed be of a shape that practically does not cover the portion of the second surface corresponding to the patterned region.

### INDUSTRIAL APPLICABILITY

The nanoimprinting mold of the present invention is not limited to use in a specific imprinting method, and may be applied for use in the thermal imprinting method that transfers patterns to thermoplastic resins, the optical imprinting method that transfers patterns onto light curable resins, the room temperature imprinting method that transfers patterns onto HSQ (Hydrogen Silses Quioxane) that does not require heat or light, the sol gel imprinting method that transfers patterns onto glass materials in gel form, the direct imprinting method that transfers patterns directly onto metal or glass, etc.

What is claimed is:

1. A nanoimprinting mold, comprising:
a patterned base plate having a patterned region, in which a fine pattern of protrusions and recesses is formed, on a first surface thereof, and a second surface having a 3σ value related to a height difference distribution within a range from 1 nm to 6 nm;
a hollowed base plate having a hollowed shape at least at a portion corresponding to the patterned region and a thickness greater than or equal to that of the patterned base plate; and
a metal film formed between the patterned base plate and the hollowed base plate so as to bond the second surface of the patterned base plate and a surface of the hollowed base plate that faces the second surface.

2. A nanoimprinting mold as defined in claim 1, wherein:
the metal film is formed to be of a shape that practically does not cover the second surface corresponding to the patterned region.

3. A nanoimprinting mold as defined in claim 2, wherein:
the transmissivity of the metal film with respect to light having a wavelength of 400 nm or less is 1% or less.

4. A nanoimprinting mold as defined in claim 1, wherein:
the material of the metal film is a metal material selected from a group of materials consisting of Ti, Al, Si, V, Cr, Fe, Co, Ni, Cu, Zn, Ga, Ge, Zr, Nb, Mo, Ru, Rh, Pd, Ag, In, Sn, Hf, Ta, Pt, and Au, or an alloy material that includes one or more materials selected from the group of materials.

5. A method for producing a nanoimprinting mold, comprising:
preparing a patterned base plate having a patterned region, in which a fine pattern of protrusions and recesses is formed, on a first surface thereof, and a second surface having a 3σ value related to a height difference distribution within a range from 1 nm to 6 nm and a hollowed base plate having a hollowed shape at least at a portion corresponding to the patterned region and a thickness greater than or equal to that of the patterned base plate; and
bonding the second surface of the patterned base plate and a surface of the hollowed base plate via a metal film.

6. A method for producing a nanoimprinting mold as defined in claim 5, wherein:
the bonding via the metal film is executed by:
forming a first metal layer on the second surface of the patterned base plate;
forming a second metal layer on the surface of the hollowed base plate; and
placing the first metal layer and the second metal layer in close contact to bond the first and second metal layers.

7. A method for producing a nanoimprinting mold as defined in claim 6, wherein:
the bonding of the first metal layer and the second metal layer is executed by the atomic diffusion bonding method.

8. A method for producing a nanoimprinting mold as defined in claim 7, wherein:
the material of the patterned base plate is one of Si, a Si oxide, a Si nitride, quartz, and metal;
the thickness of the patterned substrate is within a range from 0.3 mm to 1.5 mm; and
the bonding of the first metal layer and the second metal layer is executed in a state in which external pressure is approximately is 5 g/cm².

9. A method for producing a nanoimprinting mold as defined in claim 6, wherein:
the first metal layer is formed to be of a shape that practically does not cover the second surface corresponding to the patterned region.

10. A method for producing a nanoimprinting mold as defined in claim 6, wherein:
the material of the first metal layer and/or the second metal layer is a metal material selected from a group of materials consisting of Ti, Al, Si, V, Cr, Fe, Co, Ni, Cu, Zn, Ga, Ge, Zr, Nb, Mo, Ru, Rh, Pd, Ag, In, Sn, Hf, Ta, Pt, and Au, or an alloy material that includes one or more materials selected from the group of materials.
